(19) United States
(12) Patent Application Publication
(10) Pub. No.: US 2026/0003305 A1
(43) Pub. Date: Jan. 1, 2026

(54) TONER CONTAINER, CARTRIDGE, AND IMAGE FORMING APPARATUS

(71) Applicant: CANON KABUSHIKI KAISHA, Tokyo (JP)

(72) Inventors: HIROOMI MATSUZAKI, Shizuoka (JP); TORU OGUMA, Shizuoka (JP); KAZUKI MATSUMOTO, Shizuoka (JP); TATSURO HARADA, Shizuoka (JP); NORITOMO YAMAGUCHI, Kanagawa (JP); AKINORI MITSUMATA, Tokyo (JP); KEI HAYASHIDA, Tokyo (JP)

(21) Appl. No.: 19/320,991

(22) Filed: Sep. 5, 2025

Related U.S. Application Data
(63) Continuation of application No. PCT/JP2024/009336, filed on Mar. 11, 2024.

(30) Foreign Application Priority Data
Mar. 14, 2023 (JP) 2023-039201
Mar. 14, 2023 (JP) 2023-039202

(51) Int. Cl. G03G 15/08

(52) U.S. Cl. CPC G03G 15/0868; G03G 15/0881; G03G 2215/068

(57) ABSTRACT

A toner container configured to be detachably mountable to an apparatus main body includes a container chamber and is provided with an outlet port for discharging the contained toner to outside, a filter configured to prevent passage of the toner and allow passage of air, an air chamber that is provided with an inlet port for receiving the air and is adjacent to the container chamber with the filter in between, and a passage that is provided in the container chamber to pass the toner and has a first opening for receiving the toner and a second opening configured to communicate with the outlet port, the passage extending from the first opening to the second opening, wherein, the only opening through which the air flowing in from the inlet port and the toner is discharged from the container chamber is the outlet port.

### CROSS-REFERENCE TO RELATED APPLICATIONS

This application is a Continuation of International Patent Application No. PCT/JP2024/009336, filed Mar. 11, 2024, which claims the benefit of Japanese Patent Applications No. 2023-039201, filed Mar. 14, 2023, and No. 2023-039202, filed Mar. 14, 2023, all of which are hereby incorporated by reference herein in their entirety.

### BACKGROUND

### Field of the Technology

The present disclosure relates to a toner container, a cartridge, and an image forming apparatus.

### Description of the Related Art

In electrophotographic image forming apparatuses, it is widely known that a toner cartridge containing toner as a developer used in image formation and a process cartridge for performing an electrophotographic process are attachable to and detachable from the apparatus main body. Japanese Patent Laid-Open No. 4678735 describes a powder supply device that uses both a pump configured to eject air into a powder container containing toner and a pump configured to suck in toner and air to convey the toner contained in the powder container to a destination.

### SUMMARY

The present disclosure is directed to providing a new form of toner container that is configured to discharge toner by allowing air to flow into a chamber that contains the toner.

The present disclosure is a toner container that includes a container chamber that contains toner and is provided with an outlet port for discharging the toner contained in the container chamber to outside of the toner container, a filter configured to suppress passage of the toner and allow passage of air, an air chamber that has an inlet port for receiving air and is adjacent to the container chamber with the filter in between, and a passage that is provided in the container chamber to pass the toner contained in the container chamber and has a first opening for receiving the toner contained in the container chamber and a second opening configured to communicate with the outlet port, the passage extending from the first opening to the second opening, wherein, in a state where the air is flowing in from the inlet port, the only opening through which the toner or the air is discharged from the container chamber is the outlet port.

Features of the present disclosure will become apparent from the following description of embodiments with reference to the attached drawings.

### BRIEF DESCRIPTION OF THE DRAWINGS

FIG. 1 is a schematic cross-sectional view of an image forming apparatus according to a first embodiment.

FIG. 2 is a schematic cross-sectional view of a process cartridge according to the first embodiment.

FIG. 3A is a schematic cross-sectional view of a toner cartridge according to the first embodiment.

FIG. 3B is a schematic cross-sectional view of the toner cartridge according to the first embodiment.

FIG. 4 is a schematic perspective view of the toner cartridge according to the first embodiment.

FIG. 5 is a schematic exploded perspective view of the toner cartridge according to the first embodiment.

FIG. 6 is a schematic perspective view of a ventilation member according to the first embodiment.

FIG. 7 is a partial schematic cross-sectional view of the toner cartridge according to the first embodiment.

FIG. 8 is a schematic top view of a second frame of the toner cartridge according to the first embodiment.

FIG. 9 is a schematic cross-sectional view of the toner cartridge and the process cartridge according to the first embodiment.

FIG. 10 is a schematic cross-sectional view of a toner cartridge according to a first modification example.

FIG. 11 is a schematic cross-sectional view of a toner cartridge according to a second modification example.

FIG. 12A is a schematic diagram illustrating conveyance of toner in the toner cartridge according to the first embodiment.

FIG. 12B is a schematic diagram illustrating conveyance of toner in the toner cartridge according to the first embodiment.

FIG. 12C is a schematic diagram illustrating conveyance of toner in the toner cartridge according to the first embodiment.

FIG. 13 is a schematic cross-sectional view of a toner cartridge according to a second embodiment.

FIG. 14 is a cross-sectional view of a toner cartridge according to a modification example of the second embodiment.

### DESCRIPTION OF THE EMBODIMENTS

Hereinafter, modes for carrying out the present disclosure will be described in detail based on embodiments with reference to the drawings. However, the dimensions, materials, shapes, and relative positions of the components in the embodiments may be changed as appropriate depending on the configuration and various conditions of the apparatus to which the disclosure is applied. That is, the scope of the present disclosure is not limited to the following embodiments.

Examples of an image forming apparatus described below include copiers, printers, multifunction peripherals, commercial printing devices, and the like. In such an image forming apparatus, an image is formed on recording materials based on image information input through an external device or image information read from an original document. The recording materials include sheet materials of various substances and shapes, such as plain paper and thick paper, plastic film, coated paper, sheets of special shapes such as envelopes and index paper, and cloth.

### First Embodiment

### <Image Forming Apparatus>

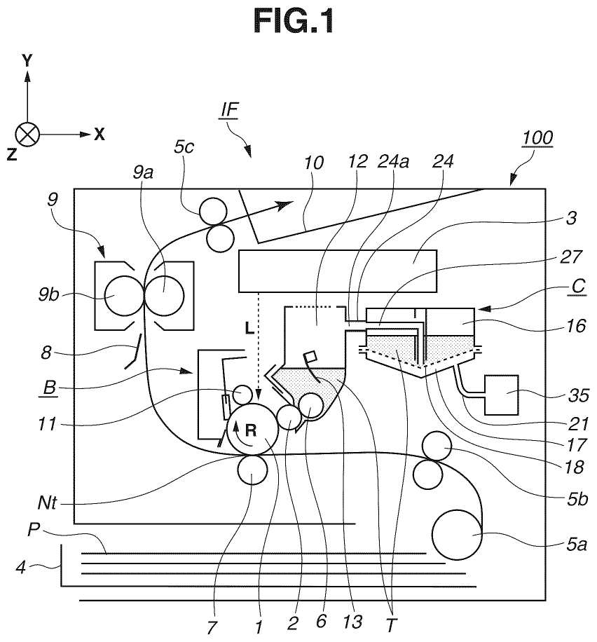

FIG. 1 is a schematic cross-sectional view of a configuration of an image forming apparatus IF according to a first embodiment of the present disclosure. The following description will be given using a coordinate system in FIG. 1 in which the up-down direction (vertical direction) is a Y direction and the left-right direction (horizontal direction) is an X direction. In the first embodiment, the X direction is a direction orthogonal to the width direction of a sheet P, which is a sheet-shaped recording material conveyed through the image forming apparatus.

The image forming apparatus IF has an apparatus main body 100, a process cartridge B that is attachable to and detachable from the apparatus main body 100, and a toner cartridge C that is attachable to and detachable from the apparatus main body 100. Image formation is performed on the sheet P in a state where the process cartridge B and the toner cartridge C are attached to the apparatus main body 100. In addition to the process cartridge B and the toner cartridge C, the apparatus main body 100 has a scanner unit 3, a tray 4 as a sheet container unit, a feed roller 5a, a conveyance roller pair 5b, a transfer roller 7, a fixing unit 9, a discharge roller pair 5c, and a paper stack tray 10.

The scanner unit 3 as an exposure unit uses a polygon mirror to irradiate a photosensitive drum 1 as an image carrier with laser light L corresponding to image information input from an external device, thereby scanning and exposing the surface of the photosensitive drum 1. This exposure forms an electrostatic latent image corresponding to the image information on the surface of the photosensitive drum 1. The scanner unit 3 is not limited to a laser scanner device, and may be a light emitting diode (LED) exposure device having an LED array in which a plurality of LEDs is arranged along the longitudinal direction of the photosensitive drum 1, for example.

The tray 4 serving as a sheet container unit contains sheets P that are recording materials. The feed roller 5a is a feed unit for picking up the sheet P contained in the tray 4, and the conveyance roller pair 5b is a conveyance unit for conveying the sheet P picked up by the feed roller 5a.

The transfer roller 7 as a transfer unit is positioned to face the photosensitive drum 1. When the sheet P is not being conveyed, the photosensitive drum 1 and the transfer roller 7 contact each other to form a transfer part Nt. The sheet P is conveyed toward the transfer part Nt by the conveyance roller pair 5b, and the toner image is transferred to the sheet P nipped in the transfer part Nt.

The fixing unit 9 is a thermal fixing unit that fixes an image by heating and melting the toner on the sheet P. The fixing unit includes a heating roller 9a and a pressure roller 9b that is in pressure contact with the heating roller 9a. The discharge roller pair 5c discharges the sheet P, on which the image has been fixed by the fixing unit 9, onto the paper stack tray 10 serving as a stacking unit.

The process cartridge B has the photosensitive drum 1 as a photosensitive member, a development roller 2 as a development member, a charging roller 11 as a charging unit, a toner chamber 12 that contains toner T to be supplied to the development roller 2, and the like. The toner cartridge C contains the toner T that can be supplied to the toner chamber 12 of the process cartridge B.

### <Image Forming Operation>

Next, an image forming operation by an image forming unit of the image forming apparatus IF will be described. In the present embodiment, the image forming unit consists of the process cartridge B, the scanner unit 3, and the transfer roller 7. When the image forming apparatus IF receives a signal to start image formation on the sheet P, the photosensitive drum 1 is rotationally driven in the direction of arrow R in FIG. 1. The charging roller 11 contacts the outer peripheral surface of the photosensitive drum 1 and charges the drum surface uniformly and evenly. In image formation, the sheet P is conveyed from the tray 4 provided at the bottom of the apparatus main body 100.

In synchronization with the conveyance of the sheet P, the photosensitive drum 1 is selectively exposed to light by the scanner unit 3 to form a latent image. The toner T contained in the toner chamber 12 is supplied to the development roller 2 and is carried in a thin layer on the surface of the development roller 2 by a development blade 15. When a development bias is applied to the development roller 2, the development roller 2 supplies toner T1 to the photosensitive drum 1 in accordance with the latent image, and develops the latent image into a toner image.

The sheet P is conveyed by a conveyance unit such as a roller to the transfer part Nt where the photosensitive drum 1 and the transfer roller 7 contact each other. The developed toner image is then transferred from the photosensitive drum 1 to the sheet P by the transfer roller 7 to which the transfer bias is applied. Next, the sheet P is guided by a conveyance guide 8 and conveyed to the fixing unit 9, where the image is fixed to the sheet P. The sheet P having passed through the fixing unit 9 is discharged onto the paper stack tray 10 provided at the top of the apparatus main body 100, whereby the image forming operation is completed.

### <Process Cartridge>

Next, the process cartridge B will be described in more detail. In applying the present disclosure, the process cartridge includes a photosensitive drum and a process unit acting on the photosensitive drum. Examples of the process unit include a charging unit for charging the surface of the photosensitive drum, a development unit for forming a toner image on the photosensitive drum, and a cleaning unit for removing residual toner on the surface of the photosensitive drum, and the like.

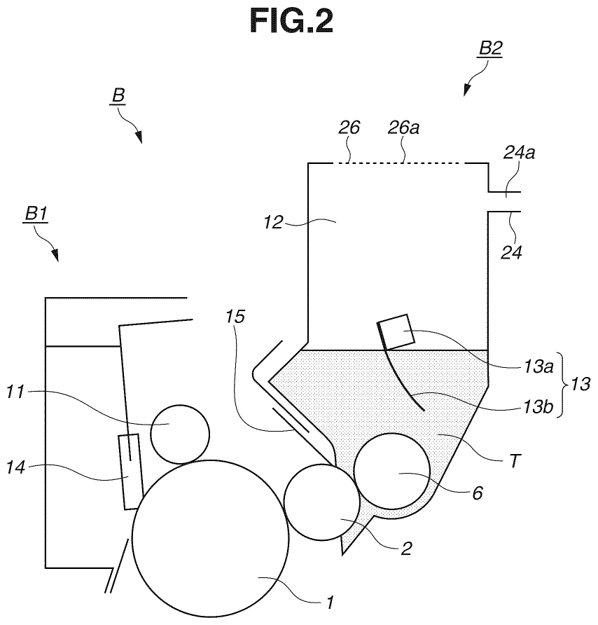

FIG. 2 is a schematic cross-sectional view of a configuration of the process cartridge B. The process cartridge B of the first embodiment consists of a drum unit B1 as an image carrier unit and a development unit B2 as a development unit. The drum unit B1 includes the charging roller 11 as a charging unit positioned in the vicinity of the photosensitive drum 1, and an elastic cleaning blade 14 as a cleaning unit.

The development unit B2 includes the development roller 2 as a development member, the development blade 15, a developer supply roller 6, the toner chamber 12 as a container unit for containing the toner T, and an agitation member 13 for agitating the toner T. The agitation member 13 has a rotational shaft 13a and an agitation sheet 13b, and rotates to agitate the toner T contained in the toner chamber 12. The toner chamber 12 is provided with a passage 24 (coupling passage) through which the toner supplied from the toner cartridge C passes, a receiving port 24a for receiving the supplied toner, and an opening 26 (exhaust unit) for passing air through the toner chamber 12. When the image forming apparatus IF is in a posture during use, the receiving port 24a and the opening 26 for passing air in the toner chamber 12 are provided on the upper surface of the toner chamber 12, and a filter 26a is provided in the opening 26 as a ventilation member.

### <Toner Cartridge>

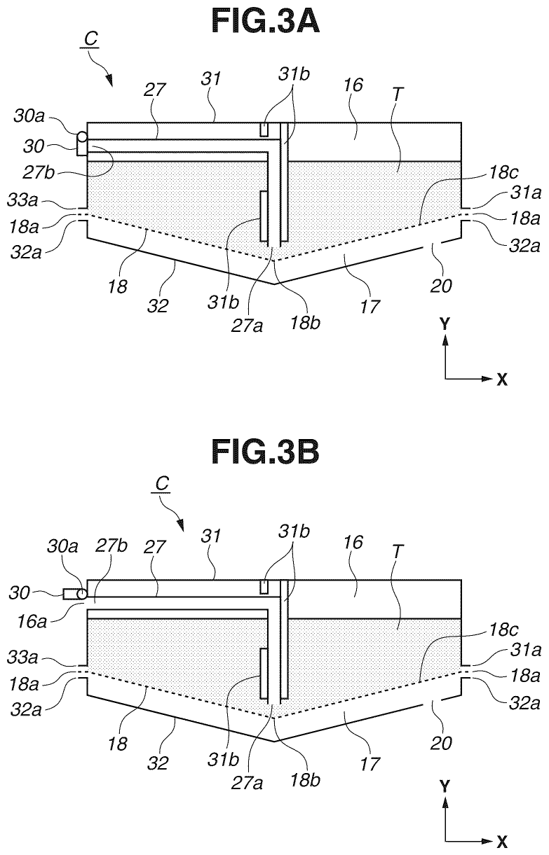

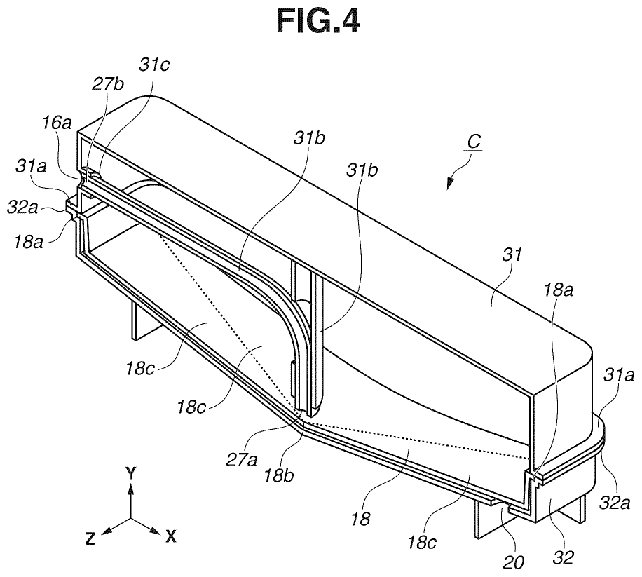

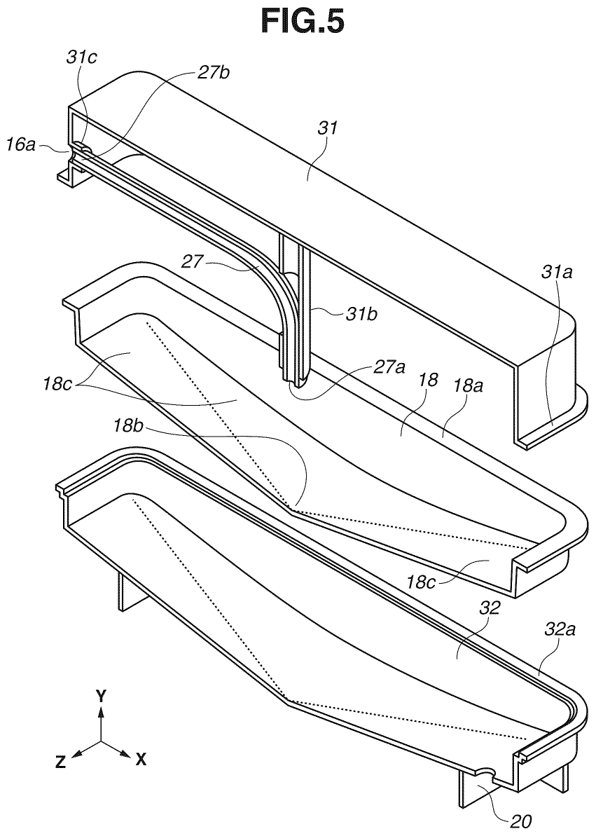

Next, the toner cartridge C will be described in more detail. FIGS. 3A and 3B are schematic cross-sectional views of a main configuration of the toner cartridge C. Also, FIG. 4 is a schematic perspective view of the configuration of the toner cartridge C, and FIG. 5 is an exploded perspective view of the configuration of the toner cartridge C.

According to the configuration of the present embodiment, it is possible to discharge the toner T from the toner cartridge C serving as a toner container toward the process cartridge B by ejecting air from a pump 35 described below, and supply the toner T to the process cartridge B. As described above, the toner cartridge C is configured to be freely attached to and detached from the apparatus main body 100. That is, after the toner T contained in the toner cartridge C runs out, new toner can be supplied to the process cartridge B by replacing only the toner cartridge C, and the image forming apparatus can be used continuously.

As illustrated in FIGS. 3A and 3B, the toner cartridge C has a toner container chamber 16 (first chamber) that contains the toner T to be supplied to the process cartridge B, a filter 18 as a ventilation member, an air chamber 17 (second chamber), and a passage 27 through which the toner T passes. The toner container chamber 16 is provided with an outlet port 16a for discharging the toner from the toner container chamber 16. The air chamber 17 is provided with an inlet port 20 for allowing air to flow in. The passage 27 has a first opening 27a for receiving the toner T from the toner container chamber 16 and a second opening 27b configured to communicate with the outlet port 16a, and extends from the first opening 27a to the second opening 27b. The first opening 27a faces the filter 18 with a gap therebetween.

As illustrated in FIGS. 4 and 5, the toner cartridge C has a frame formed by a first frame 31 and a second frame 32, and the filter 18 is arranged between the first frame 31 and the second frame 32. The first frame 31 and the filter 18 form the space of the toner container chamber 16, and the filter 18 and the second frame 32 form the space of the air chamber 17.

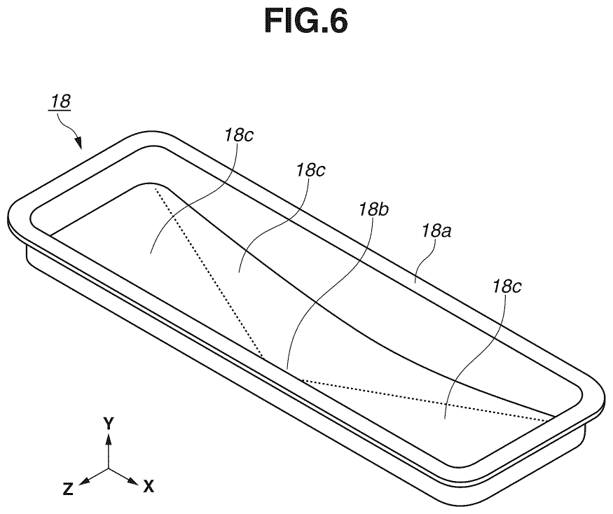

FIG. 6 is a schematic perspective view of a configuration of the filter 18. As illustrated in FIGS. 4 to 6, the filter 18 has a flange 18a (filter flange portion), the first frame 31 has a flange 31a (first flange portion), and the second frame 32 has a flange 32a (second flange portion). The flange 18a of the filter 18 is provided around the entire circumference in the horizontal direction (X and Z directions). Similarly, the flange 31a of the first frame 31 and the flange 32a of the second frame 32 are also provided around the entire circumference in the horizontal direction (X and Z directions).

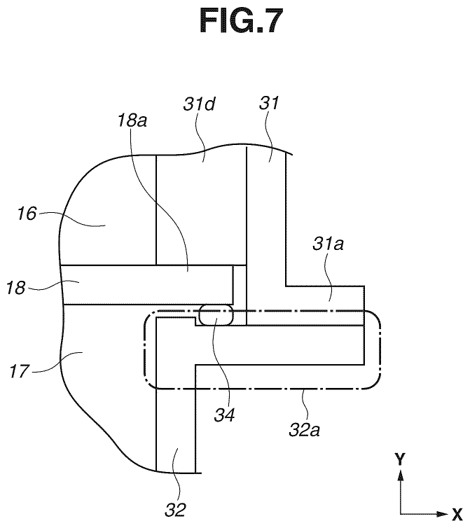

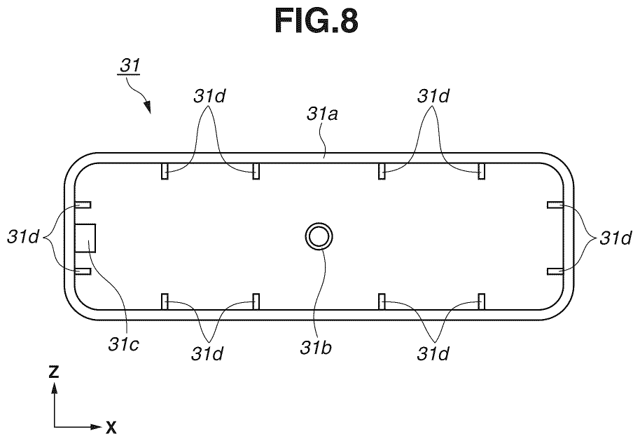

FIG. 7 is a schematic partial cross-sectional view of a coupling structure of the first frame 31, the second frame 32, and the filter 18. FIG. 8 is a schematic plan view of the first frame 31 as seen from the filter 18 side toward the first frame 31 in the posture of the toner cartridge C where the first frame 31, the filter 18, and the second frame 32 are aligned in this order. As illustrated in FIG. 8, the first frame 31 has ribs 31d (protruding portions) protruding inward from the inner wall of the first frame 31 on the inside of the frame constituting the toner container chamber 16. The plurality of ribs 31d is provided on the inner peripheral surface of the first frame 31 in correspondence with the region where the flange 31a of the first frame 31 is formed.

As illustrated in FIG. 7, in constructing the frame of the toner cartridge C, the flanges 31a and 32a are joined together such that air does not leak between the flanges. The method for joining the flange 31a and the flange 32a here may be selected as appropriate from ultrasonic welding, heat welding, adhesion with a solvent such as an adhesive, joining with screws, or the like.

In constructing the frame of the toner cartridge C by joining the first frame 31 and the second frame 32, the flange 18a and a flexible seal member 34 are sandwiched between the first frame 31 and the second frame 32. More specifically, as illustrated in FIG. 7, the flange 31a and the flange 32a are joined in a state where the flange 18a and the seal member 34 are sandwiched between the ribs 31d provided on the first frame 31 and the flange 32a. In the present embodiment, the seal member 34 is a flexible member such as rubber or silicon. However, the present disclosure is not limited to this, and an adhesive such as a hot melt may also be used.

### [Toner Container Chamber 16]

The toner container chamber 16 is provided with the outlet port 16a for discharging the contained toner T to the outside of the toner cartridge C. As illustrated in FIG. 3A, the toner container chamber 16 is formed by the first frame 31 and a space whose bottom surface is surrounded by the filter 18, and contains the toner T. The outlet port 16a of the toner container chamber 16 is an opening formed in the first frame 31. A sealing member 30 (opening and closing member) is provided at a position in the first frame 31 where the outlet port 16a is provided.

As illustrated in FIG. 3A, the sealing member 30 seals the outlet port 16a in a state where the toner cartridge C is not mounted in the apparatus main body 100 or is not connected to the passage 24 coupling the receiving port 24a of the process cartridge B and the outlet port 16a. This makes it possible to prevent the toner contained in the toner container chamber 16 from leaking out of the toner cartridge C.

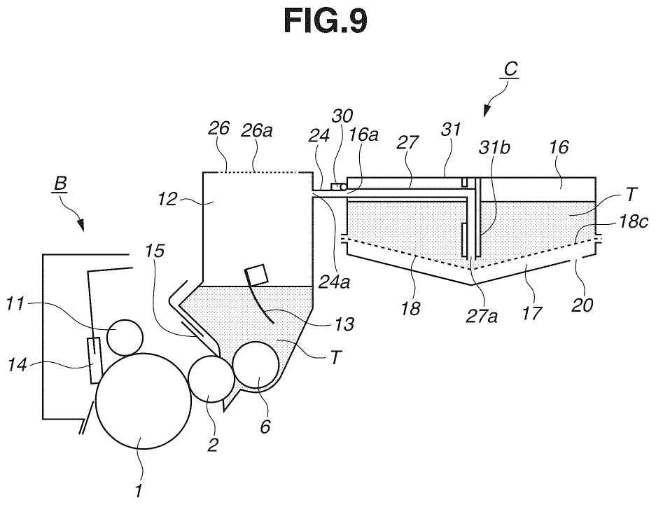

On the other hand, as illustrated in FIG. 3B, when the toner cartridge C is mounted in the apparatus main body 100 and the passage 24 is connected to the outlet port 16a, the sealing member 30 moves to a position at which the outlet port 16a is opened. Accordingly, as illustrated in FIG. 9, the outlet port 16a of the toner cartridge C and the receiving port 24a of the process cartridge B are coupled by the passage 24, and the toner T contained in the toner container chamber 16 of the toner cartridge C can be supplied to the process cartridge B. FIG. 9 is a schematic cross-sectional view of the toner cartridge C and the process cartridge B in a connected state.

In the present embodiment, the sealing member 30 is used to open or seal the outlet port 16a by rotating around a rotation axis 30a. However, the present disclosure is not limited to this, and the sealing member 30 may be a member or component that opens or seals the outlet port 16a by a sliding movement or another movement such as retracting into the toner container chamber 16.

As illustrated in FIGS. 4 and 8, the first frame 31 has a support portion 31b (first support portion) for supporting the vicinity of the first opening 27a and a support portion 31c (second support portion) for supporting the vicinity of the second opening 27b, on the inner surface constituting the internal space of the toner container chamber 16. The support portion 31b and the support portion 31c protrude from the inner surface of the first frame 31 toward the inside of the toner container chamber 16, and support the posture of the passage 27 by contacting the outer periphery of the passage 27 in the vicinities of the first opening 27a and the second opening 27b. The support portion 31b and the support portion 31c may be integrally formed at the time of molding of the first frame 31 constituting the toner container chamber 16, or may be formed by fixing members separate from the first frame 31 to the first frame 31.

### [Air Chamber 17]

As illustrated in FIG. 3A, the air chamber 17 is provided with the inlet port 20 (intake port) for receiving air, and is adjacent to the toner container chamber 16 with the filter 18 in between.

The air chamber 17 is formed by a space surrounded by the second frame 32 and the filter 18.

More specifically, in a posture of the toner cartridge C in which the toner container chamber 16, the filter 18, and the air chamber 17 are aligned from top to bottom with respect to the direction of gravity, the air chamber 17 constitutes a space with the filter 18 as the ceiling surface and the second frame 32 as the bottom and side surfaces. The air chamber 17 is one continuous space, and there is no partition that separates the top and bottom surfaces of the air chamber 17. The air chamber 17 is the only chamber adjacent to the toner container chamber 16 with the filter 18 in between.

The second frame 32 constituting the air chamber 17 is provided with an opening for taking in air from the outside, that is, the inlet port 20 for receiving air. In the posture of the toner cartridge C illustrated in FIGS. 3A, 3B, and 4, the inlet port 20 is provided below the filter 18 in the direction of gravity (Y direction) and is shifted in the horizontal direction (X and Z directions) from a lowest portion 18b of the filter 18. As illustrated in FIG. 1, when the toner cartridge C is mounted in the apparatus main body 100, the inlet port 20 is connected to the pump 35 provided in the apparatus main body 100 via an air supply pipe 21. In the present embodiment, the pump 35 and the inlet port 20 are connected via the air supply pipe 21, but the present disclosure is not limited to this. The pump 35 may be directly connected to the inlet port 20, or may be connected via a passage formed by the frame of the apparatus main body 100.

### [Filter 18]

As illustrated in FIG. 6, the filter 18 has the lowest portion 18b that faces the first opening 27a at the lowest position, and a plurality of inclined portions 18c (inclined surfaces) that is inclined toward the lowest portion 18b. The bottom surface of the filter 18 is formed by the plurality of inclined portions 18c. As illustrated in FIG. 5, in the present embodiment, the bottom surface of the second frame 32 constituting the bottom of the air chamber 17 is made parallel to the shape of the inclined portions 18c constituting the bottom surface of the filter 18. That is, as illustrated in FIGS. 3A, 3B, and the like, the bottom surface of the filter 18 and the bottom surface of the second frame 32 are made approximately parallel as viewed in cross section.

The filter 18 suppresses the passage of the toner T and allows the passage of air. For example, the filter 18 can be formed by a porous member made of resin fibers, and the size and density of the pores can be set to suppress the passage of the toner T and allow the passage of air. The filter 18 can also be made of a filter material formed by heat pressing, a fibrous sheet member, or the like, for example.

As illustrated in FIGS. 5 and 6, in the present embodiment, the filter 18 consists of one continuous member. That is, the filter 18 is formed continuously in the illustrated arrow X and Z directions, which are orthogonal to the direction of gravity (Y direction), and the bottom surface of the filter 18 is provided corresponding to the entire bottom surface of the second frame 32.

### [Passage 27]

As illustrated in FIG. 4, the passage 27 is a cylindrical path for connecting the toner container chamber 16 to the outside of the toner cartridge C. The passage 27 has a first opening 27a at one end and a second opening 27b at the other end. The second opening 27b communicates with the outlet port 16a. The passage 27 can be configured by a flexible tube made of a resin such as rubber or a silicone material, or a hollow member made of a resin or metal pipe, as appropriate.

In the posture of the toner cartridge C illustrated in FIGS. 3A, 3B, and 4, the first opening 27a is provided near the lowest portion 18b of the filter 18. With respect to the direction of gravity (Y direction), the second opening 27b is arranged at a higher position than (above) the first opening 27a. That is, the toner T discharged from the toner container chamber 16 through the passage 27 extending from the first opening 27a to the second opening 27b, moves from a lower position to a higher position with respect to the direction of gravity in the position of the toner cartridge C mounted in the apparatus main body 100.

### [Modifications]

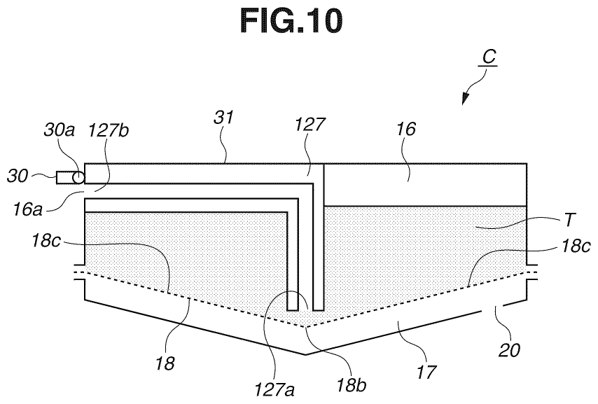

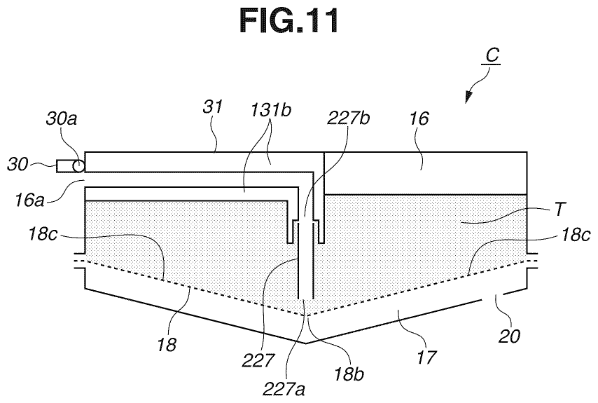

FIG. 10 is a schematic cross-sectional view of a configuration of a first modification of the present embodiment, and FIG. 11 is a schematic cross-sectional view of a configuration of a second modification of the present embodiment. As illustrated in FIGS. 10 and 11, the first and second modifications differ from the present embodiment in the configuration of the passage 27. In the following description, similar components and members as those in the first embodiment are denoted by the same reference numerals as in the first embodiment, and description thereof will be omitted.

For example, as in first modification, a passage 127 may be formed of a resin having no flexibility or the like. In this case, it is not necessary to provide a member for supporting the passage 127, such as the support portion 31b in the first embodiment, and thus the passage 127 is simpler in structure. The passage 127 has a first opening 127a and a second opening 127b corresponding to the first opening 27a and the second opening 27b of the passage 27 in the first embodiment. The passage 127 may be integrally molded with the first frame 31 using the same member as the first frame 31, or may be formed using a separate member and fixed to the first frame 31.

As in the second modification of FIG. 11, a passage 227 may be formed such that a part of the passage 227 is constituted by a support portion 131b corresponding to the support portion 31b of the first embodiment. In the passage 227 of the second modification, a member extending from a first opening 227a facing a filter 18 with a gap in between to a second opening 227b is formed by a flexible member, and the second opening 227b side of the flexible member is supported by the support portion 131b. This configuration eliminates the need to support the second opening by the support portion 31c of the first embodiment, so that the passage 227 is simpler in structure.

In the second modification, the passage 227 is formed by the support portion 131b and the flexible member. Alternatively, the passage 227 closer to the filter 18 may be formed by a material other than the flexible member and different from that of the support portion 131b. The support portion 131b may be integrally molded with the first frame 31 by using the same material as the first frame 31, or may be formed by using a different material and fixed to the first frame 31.

As described above, according to the configurations of the present embodiment and modifications, in the toner cartridge C as a whole, the air is taken in from the inlet port 20 and is mainly discharged to the outside of the toner cartridge C from the outlet port 16a. More specifically, in the configurations of the toner cartridge C of the present embodiment and modifications, in a state where air is flowing in from the inlet port 20, the only opening through which the toner T or the air is discharged from the toner container chamber 16 is the outlet port 16a. The advantageous effects of this configuration will be described below.

### <Toner Discharge Mechanism>

Next, the mechanism by which the toner Tis discharged from the toner cartridge C and supplied to the process cartridge B will be described with reference to FIGS. 1, 3A, 3B, and 9.

In the present embodiment, the air discharged by the pump 35 provided in the apparatus main body 100 flows into the toner cartridge C from the inlet port 20 through the air supply pipe 21. The air flowing in from the inlet port 20 presses the toner T contained in the toner container chamber 16 through the filter 18, so that the toner T enters the passage 27 from the first opening 27a, passes through the passage 27, and then is discharged from the outlet port 16a through the second opening 27b. That is, according to the configuration of the present embodiment, the toner T contained in the toner container chamber 16 is conveyed to the outside of the toner cartridge C only by the air supplied from the pump 35 through the inlet port 20, and is supplied to the process cartridge B. A more detailed description will be given below.

As illustrated in FIG. 1, the apparatus main body 100 of the present embodiment includes the pump 35 as an air supply unit for supplying air to the toner cartridge C. The pump 35 may be a reciprocating pump, a diaphragm pump, or a rotary pump as appropriate. The pump 35 is connected to the inlet port 20 of the air chamber 17 via the air supply pipe 21. The air discharged by the pump 35 is sent to the air chamber 17 through the inlet port 20 of the toner cartridge C as illustrated in FIGS. 3A and 3B. The air that has flowed into every corner of the air chamber 17, which is a single continuous space, passes through the filter 18 that forms the ceiling surface and then flows toward the toner container chamber 16.

The air that has flown into the toner container chamber 16 through the filter 18 fluidizes the toner T in the toner container chamber 16. Then, the air mixed with the toner T enters the passage 27 from the first opening 27a and is discharged from the outlet port 16a through the second opening 27b. As described above, in the configuration of the present embodiment, for the air mixed with the toner T in the toner container chamber 16, the passage 27 is only the passage connecting to the outside of the toner container chamber 16. Thus, the air mixed with the toner T travels toward the outlet port 16a through the passage 27. Therefore, in a state where air flows in from the inlet port 20, the air having flown into the toner cartridge C is discharged from the outlet port 16a through the passage 27, and there is no discharge path for the air other than the path from the outlet port 16a through the passage 27.

In this manner, the flow of air can be stabilized by providing the outlet port 16a through the passage 27, as only one outlet for air taken in from the inlet port 20. As a result, the toner T contained in the toner container chamber 16 can be stably discharged to the outside of the toner cartridge C. Also, by not providing any ventilation ports or outlet ports in the toner cartridge C other than the outlet port 16a, the toner T can be stably discharged solely by the force of the pump that discharges air toward the inlet port 20. If a plurality of air outlets is provided, it will be difficult to manage the flows of toner and air, so that it may be necessary to suck in the toner and air and discharge them to the outside of the toner cartridge to convey the toner stably. According to the configuration of the present embodiment, the toner T can be stably discharged without the need to provide a separate pump that sucks in air, so that the toner T can be stably conveyed with a simpler configuration.

As illustrated in FIG. 9, the air and toner T discharged from the outlet port 16a pass through the passage 24 and are supplied to the process cartridge B from the receiving port 24a. At this time, not only the toner T but also the air flows into the toner chamber 12 of the process cartridge B, and the internal pressure of the toner chamber 12 may rise instantaneously. However, as described above, the air can be released through the opening 26 provided in the top surface of the toner chamber 12 as an exhaust unit, so that it is possible to prevent a rise in the internal pressure of the toner chamber 12. The pump 35 in the present embodiment is provided in the apparatus main body 100. However, the present disclosure is not limited to this, and the pump 35 may be provided in the process cartridge B or the toner cartridge C, and may be made attachable to and detachable from the apparatus main body 100 together with the cartridge.

### <Transitions in Toner Discharge State>

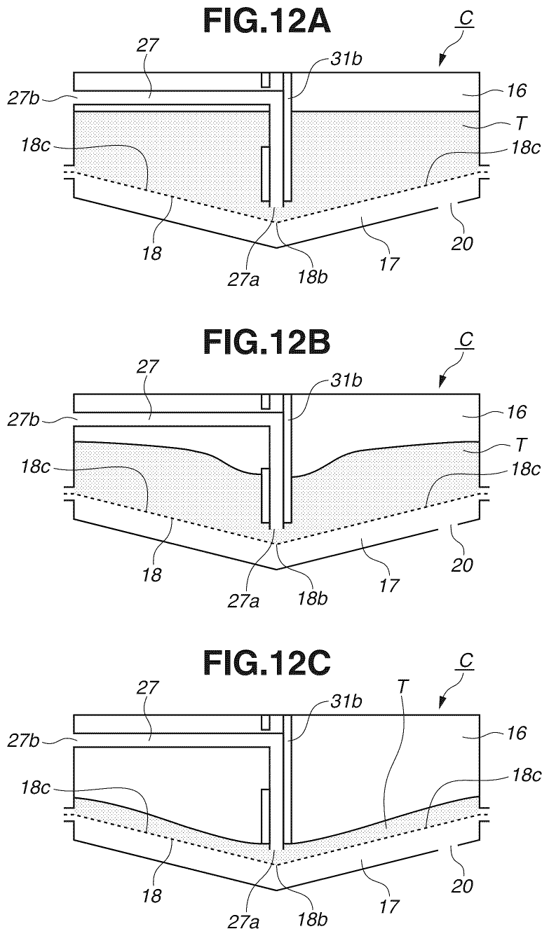

FIGS. 12A to 12C are schematic cross-sectional diagram illustrating transitions in the toner discharge state when the toner T contained in the toner container chamber 16 is discharged from the toner cartridge C. FIG. 12A illustrates a state in which the discharge of the toner T has not yet been started. FIG. 12B illustrates a state in which the discharge of the toner T via the passage 27 has started due to the air flowing in from the inlet port 20, and the toner T contained in the toner container chamber 16 is decreasing. FIG. 12C illustrates a state in which the toner T has been further discharged from the state illustrated in FIG. 12B.

In the state illustrated in FIG. 12A, when air is sent by the pump 35 from the inlet port 20 into the air chamber 17 of the toner cartridge C, the air flows toward the outlet port 16c, which is the only outlet, via the filter 18 and the passage 27. At this time, the air flows while entraining the toner T, so that the toner T enters the first opening 27a together with the air, and is then conveyed toward the outlet port 16a via the passage 27, and starts to be discharged from the outlet port 16a. Accordingly, the toner T contained in the toner container chamber 16 decreases, and the state illustrated in FIG. 12A transitions to the state illustrated in FIG. 12B.

As illustrated in FIG. 12B, when the toner T in the toner container chamber 16 decreases due to the discharge of the toner T, the surface of the toner T around the first opening 27a drops in the direction of gravity. Accordingly, the toner T contained in the toner container chamber 16 starts to collapse around the first opening 27a. At this time, the toner T is fluidized by the inflow of the air that has passed through the filter 18, so that the toner Tis conveyed toward the lowest portion 18b along the inclined surfaces of the inclined portions 18c. While the inflow of the air from the inlet port 20 continues, the toner T near the lowest portion 18b enters the passage 27 through the first opening 27a, passes through the passage 27 together with the air, and is then discharged from the outlet port 16a. As the discharge of the toner T continues, the surface of the toner T contained in the toner container chamber 16 further drops, and the state of FIG. 12B transitions to the state of FIG. 12C.

The angles of the inclined portions 18c and the flow rate of the air supplied by the pump 35 also affect the ease of discharging the toner T. In order to discharge the toner T from the entire toner container chamber 16, it is effective to increase the angles of the inclined portions 18c. However, if the angles of the inclined portions 18c are too large, the volume of toner T that can be contained in the toner container chamber 16 will decrease compared to a structure in which the angles of the inclined portions 18c are small. Then, in the case of containing a desired amount of toner T, it may be difficult to achieve size reduction of the toner cartridge C. Therefore, from the viewpoint of achieving the capacity and size reduction of the toner cartridge C, the angles of the inclined portions 18c are desirably set small as much as possible within the range in which the toner T can be discharged.

<Positioning of First Opening 27a>

As illustrated in FIGS. 3A and 3B, providing the support portion 31b allows the first opening 27a of the passage 27 to be positioned relative to the lowest portion 18b of the filter 18. The position of the first opening 27a in the toner container chamber 16 relative to the lowest portion 18b of the filter 18 affects the ease of discharging of the toner T. As illustrated in FIGS. 12A to 12C, the toner T contained in the toner container chamber 16 is fluidized by the inflow of air, and is conveyed toward the lowest portion 18b by the inclined portions 18c. Therefore, in the configuration of the present embodiment, it is most desirable to provide the first opening 27a in the vicinity of the lowest portion 18b from the viewpoint of discharging the toner T.

For example, if the passage 27 is made of a flexible member without providing the support portion 31b inside the toner container chamber 16, the position of the first opening 27a may change due to stimuli such as impact or vibration on the toner cartridge C or the movement of the toner T. If the position of the first opening 27a changes from the vicinity of the lowest portion 18b, the discharge amount of the toner T may also change because the position inside the toner container chamber 16 where the toner T gathers most is the vicinity of the lowest portion 18b.

In particular, as illustrated in FIG. 12C, if the position of the first opening 27a moves to a position where there is little toner T or where there is no toner T when the toner T is low, it may be difficult to send the toner T into the passage 27 even if air is introduced from the inlet port 20. Then, the amount of the toner T remaining in the toner container chamber 16 may be greater than that in a case where the first opening 27a is positioned in the vicinity of the lowest portion 18b. That is, properly positioning the first opening 27a allows the toner T to be stably discharged from the toner cartridge C to the outside. In addition, the amount of the toner T remaining in the toner container chamber 16 can be managed, so that it is possible to prevent the toner T from remaining in excess in the toner container chamber 16 even if the toner T can no longer be discharged from the outlet port 16a by the inflow of air.

As described in relation to the modifications of FIGS. 10 and 11, the configuration of the support portion 31b may be changed as appropriate as long as the first opening 27a can be positioned.

In the present embodiment, a configuration of the toner cartridge C as a toner container attachable to and detachable from the apparatus main body 100 has been described, but the present disclosure is not limited to this configuration. The present disclosure can also be applied to an all-in-one cartridge in which the toner cartridge C and the process cartridge B are integrated, a cartridge in which the toner cartridge C and the development unit are integrated, and the like, whereby the same advantageous effects as those described above can be obtained.

### Second Embodiment

In the first embodiment, in a state where air is flowing in from the inlet port 20, the only air flow path is the path toward the outlet port 16a via the passage 27, that is, the only air outlet provided in the toner container chamber 16 is the outlet port 16a. In contrast, a second embodiment differs from the configuration of the first embodiment in that a toner container chamber 16 is further provided with an opening 40, which is an air outlet other than an outlet port 16a. A configuration of the second embodiment is substantially the same as the first embodiment, except for the provision of the opening 40. Therefore, in the following description, members and components that are in common with those of the first embodiment are denoted with the same reference numerals, and description thereof will be omitted.

### <Opening 40>

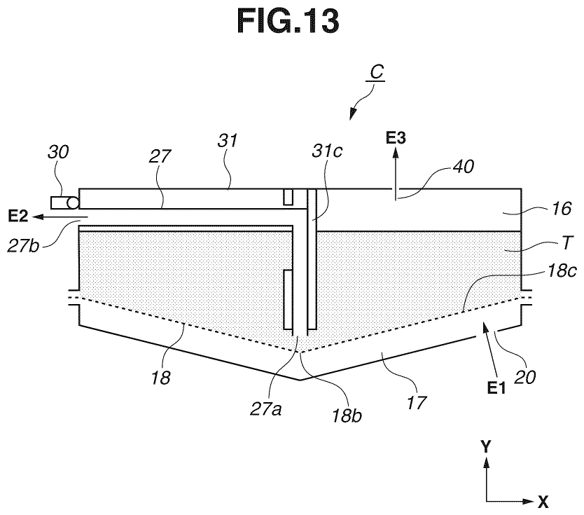

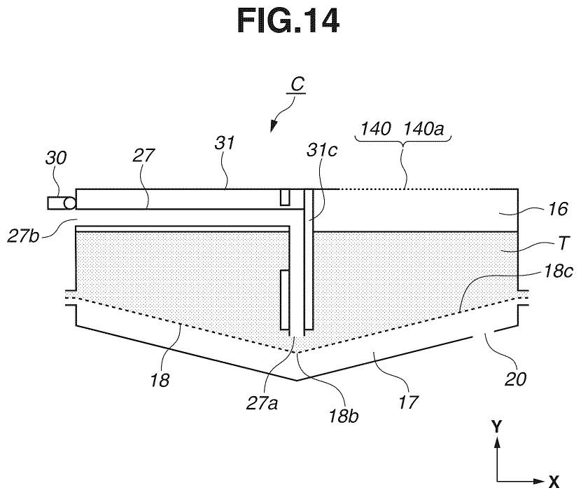

A configuration of the toner container chamber 16 in the present embodiment will be described with reference to FIGS. 13 and 14. FIG. 13 is a schematic cross-sectional view of the toner container chamber 16 in which a hole-shaped opening 40 is provided.

FIG. 14 is a schematic cross-sectional view of a toner container chamber 16 that is a modification of the present embodiment and is provided with an opening 140 and a filter 140a covering the opening 140.

In the present embodiment, as illustrated in FIG. 13, in addition to the outlet port 16a, the opening 40 is provided in a first frame 31 to connect the inside and outside of the toner container chamber 16 and enable discharge of air from the toner container chamber 16 to the outside. In the presence of the opening 40, even if the internal pressure of the toner container chamber 16 increases due to the toner cartridge C being gripped with a force stronger than expected, for example, it is possible to release the air from the opening 40 and prevent the creation of a hole through which the toner T or the air can leaks at an unintended place.

The opening (ventilation port) as a path for releasing the air may be the hole-shaped opening 40 as illustrated in FIG. 13, or may be the opening 140 and the filter 140a as in the modification illustrated in FIG. 14. Although described in detail below, a plurality of openings may be provided in the first frame 31 as long as the openings are configured to discharge the air having been taken in from an inlet port 20 to the outside of the toner cartridge C mainly from the outlet port 16a. In this case, a plurality of hole-shaped openings 40 as illustrated in FIG. 13 may be provided, or one or more hole-shaped openings 40 and one or more openings 140 having the filter 140a may be provided.

### [Comparison of Ventilation Volumes of Outlet Port 16a and Opening 40]

As described above, in order to stably discharge the toner T from the toner container chamber 16 by the air flowing in from the inlet port 20, it is necessary to make a configuration in which the air is mainly discharged from the outlet port 16a. Therefore, in the present embodiment, the opening 40 needs to satisfy a condition described below when air (arrow E1) flows into the inlet port 20. The condition is that the opening 40 is configured such that, when comparing a ventilation volume G2 of the air discharged from the outlet port 16a (flow path E2) with a ventilation volume G3 of the air discharged from the opening 40 (flow path E3), the ventilation volume G2 is greater than the ventilation volume G3.

As described above, in the present embodiment, the ventilation volume G2 from the outlet port 16a is set to be larger than the ventilation volume G3 from the opening 40. Therefore, the toner T is discharged from the outlet port 16a by the air discharged by the pump 35, through the passage 27 instead of the opening 40. Conversely, if the ventilation volume G2 from the outlet port 16a is smaller than the ventilation volume G3 from the opening 40, the air discharged by the pump 35 will be mainly discharged from the opening 40, making it difficult to discharge the toner T from the outlet port 16a.

The above-described relationship in ventilation volume can be verified by measuring and comparing the ventilation volume G2 from the outlet port 16a and the ventilation volume G3 from the opening 40 during a certain time period while air is flowing into the inlet port 20. In the modification illustrated in FIG. 14, the opening 140 satisfies the same condition as the opening 40 of the present embodiment, and the same method can be used to verify the ventilation volumes. However, it is necessary to measure the ventilation volume from the opening 140 by the amount of air discharged from the opening 140 covered with the filter 140a and compare with the ventilation volume G2 from the outlet port 16a.

Even in the case of providing the toner container chamber 16 with a plurality of openings, it is necessary to configure the toner container chamber 16 such that the ventilation volume G2 from the outlet port 16a is greater than the sum of ventilation volumes from all the openings. Configuring the toner container chamber 16 in this manner makes it possible to stably discharge the toner T from the outlet port 16a. Also in the case of providing the toner container chamber 16 with a plurality of openings, the same method as described above can be used to verify the ventilation volumes.

As described above, according to the configurations of the present embodiment and modifications, even if the toner cartridge C is provided with openings other than the outlet port 16a (the opening 40, the opening 140, and the filter 140a), the toner T can be stably discharged from the outlet port 16a through the passage 27.

In the above-described embodiments, the image forming apparatus IF is a monochrome image forming apparatus. However, the present disclosure is not limited to this and the image forming apparatus IF can be a color image forming apparatus. In this case, similar advantageous effects can be obtained by adopting the configurations of the present disclosure to a plurality of toner cartridges that stores toners of different colors and a plurality of process cartridges.

The disclosure of the present embodiment includes the following configurations.

### Configuration 1

A toner container including:
a container chamber that contains toner and is provided with an outlet port for discharging the toner contained in the container chamber to outside of the toner container;
a filter configured to suppress passage of the toner and allow passage of air;
an air chamber that is provided with an inlet port for receiving the air and is adjacent to the container chamber with the filter in between; and
a passage that is provided in the container chamber to pass the toner contained in the container chamber and has a first opening for receiving the toner contained in the container chamber and a second opening configured to communicate with the outlet port, the passage extending from the first opening to the second opening,
wherein, in a state where the air is flowing in from the inlet port, the only opening through which the toner or the air is discharged from the container chamber is the outlet port.

### Configuration 2

The toner container according to configuration 1, further including a sealing member that connects the outlet port to the outside of the toner container in a state where the toner is being discharged from the outlet port, and that is capable of sealing the outlet port in a state where the toner is not being discharged from the outlet port.

### Configuration 3

The toner container according to configuration 1, wherein the passage is formed by a flexible member.

### Configuration 4

The toner container according to configuration 1, wherein the filter has an inclined portion that is inclined such that a position facing the first opening is the lowest in a posture of the toner container in which the container chamber, the filter, and the air chamber are aligned in this order from top to bottom with respect to a direction of gravity.

### Configuration 5

The toner container according to configuration 1, wherein the second opening is provided above the first opening in a posture of the toner container in which the container chamber, the filter, and the air chamber are aligned in this order from top to bottom with respect to a direction of gravity.

### Configuration 6

The toner container according to configuration 1, further including a first frame and a second frame constituting a frame of the toner container,
wherein the filter is arranged between the first frame and the second frame, the first frame and the filter form a space of the container chamber, and the filter and the second frame form a space of the air chamber.

### Configuration 7

The toner container according to configuration 6, wherein the outlet port is provided in the first frame.

### Configuration 8

The toner container according to configuration 6, wherein the inlet port is provided in the second frame.

### Configuration 9

The toner container according to configuration 6, wherein the first frame has a support portion for supporting a vicinity of the first opening of the passage, and the support portion supports the vicinity of the first opening inside the container chamber.

### Configuration 10

The toner container according to configuration 6, wherein the first frame constitutes at least a part of the passage.

### Configuration 11

A cartridge including:
the toner container according to any one of configurations 1 to 10; and
a development unit that has a development member that carries toner and a toner chamber that receives the toner discharged from the outlet port of the toner container.

### Configuration 12

An image forming apparatus including:
the toner container according to any one of configurations 1 to 10; and
an image forming unit configured to form an image on a recording material using the toner discharged from the outlet port of the toner container.

### Configuration 13

The image forming apparatus according to configuration 12, further including a pump configured to eject air toward the inlet port of the toner container.

### Configuration 14

A toner container including:
a container chamber that contains toner and is provided with an outlet port for discharging the toner contained in the container chamber to outside of the toner container;
a filter configured to suppress passage of the toner and allow passage of air;
an air chamber that is provided with an inlet port for receiving the air and is adjacent to the container chamber with the filter in between;
at least one ventilation port that connects inside and outside of the container chamber; and
a passage that is provided in the container chamber to pass the toner contained in the container chamber and has a first opening for receiving the toner contained in the container chamber and a second opening configured to communicate with the outlet port, the passage extending from the first opening to the second opening,
wherein, in a state where the air is flowing in from the inlet port, of the air discharged from the container chamber to the outside, the air discharged from the outlet port has the largest ventilation volume.

### Configuration 15

The toner container according to configuration 14, further including a sealing member that connects the outlet port to the outside of the toner container in a state where the toner is being discharged from the outlet port, and that is capable of sealing the outlet port in a state where the toner is not being discharged from the outlet port.

### Configuration 16

The toner container according to configuration 14, wherein the passage is formed by a flexible member.

### Configuration 17

The toner container according to configuration 14, wherein the filter has an inclined portion that is inclined such that a position facing the first opening is the lowest in a posture of the toner container in which the container chamber, the filter, and the air chamber are aligned in this order from top to bottom with respect to a direction of gravity.

### Configuration 18

The toner container according to configuration 14, wherein the second opening is provided above the first opening in a posture of the toner container in which the container chamber, the filter, and the air chamber are aligned in this order from top to bottom with respect to a direction of gravity.

### Configuration 19

The toner container according to configuration 14, further including a first frame and a second frame constituting a frame of the toner container,
wherein the filter is arranged between the first frame and the second frame, the first frame and the filter form a space of the container chamber, and the filter and the second frame form a space of the air chamber.

### Configuration 20

The toner container according to configuration 19, wherein the outlet port is provided in the first frame, and the inlet port is provided in the second frame.

The toner container according to configuration 19, wherein the ventilation port is provided in the first frame.

### Configuration 22

A cartridge including:
the toner container according to any one of configurations 14 to 21; and
a development unit that has a development member that carries toner and a toner chamber that receives the toner discharged from the outlet port of the toner container.

### Configuration 23

An image forming apparatus including:
the toner container according to any one of configurations 14 to 21; and
an image forming unit configured to form an image on a recording material using the toner discharged from the outlet port of the toner container.

### Configuration 24

The image forming apparatus according to configuration 23, further including a pump configured to eject air toward the inlet port of the toner container.

The present disclosure is not limited to the above-described embodiments, and various modifications and variations can be made without departing from the spirit and scope of the present disclosure. Therefore, the following claims are appended to apprise the public of the scope of the present disclosure.

According to the present disclosure, it is possible to provide a new form of a toner container that is configured to discharge toner by allowing air to flow into a chamber that contains the toner.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A toner container configured to be attachable to and detachable from an apparatus main body of an image forming apparatus, the toner container comprising:
a container chamber that contains toner and is provided with an outlet port for discharging the contained toner to outside of the toner container;
a filter configured to prevent passage of the toner and allow passage of air;
an air chamber that is provided with an inlet port for receiving the air and is adjacent to the container chamber with the filter in between; and
a passage that is provided in the container chamber to pass the toner contained in the container chamber and has a first opening for receiving the toner contained in the container chamber and a second opening configured to communicate with the outlet port, the passage extending from the first opening to the second opening,
wherein, in a state where the air is flowing in from the inlet port, the only opening through which the toner or the air is discharged from the container chamber is the outlet port.

2. The toner container according to claim 1, further comprising a sealing member that connects the outlet port to the outside of the toner container in a state where the toner is being discharged from the outlet port, and that is capable of sealing the outlet port in a state where the toner is not being discharged from the outlet port.

3. The toner container according to claim 1, wherein the passage is formed by a flexible member.

4. The toner container according to claim 1, wherein the filter has an inclined portion that is inclined such that a position facing the first opening is the lowest in a posture of the toner container in which the container chamber, the filter, and the air chamber are aligned in this order from top to bottom with respect to a direction of gravity.

5. The toner container according to claim 1, wherein the second opening is provided above the first opening in a posture of the toner container in which the container chamber, the filter, and the air chamber are aligned in this order from top to bottom with respect to a direction of gravity.

6. The toner container according to claim 1, further comprising a first frame and a second frame constituting a frame of the toner container,
wherein the filter is arranged between the first frame and the second frame, the first frame and the filter form a space of the container chamber, and the filter and the second frame form a space of the air chamber.

7. The toner container according to claim 6, wherein the outlet port is provided in the first frame.

8. The toner container according to claim 6, wherein the inlet port is provided in the second frame.

9. The toner container according to claim 6, wherein the first frame has a support portion for supporting a vicinity of the first opening of the passage, and the support portion supports the vicinity of the first opening inside the container chamber.

10. The toner container according to claim 6, wherein the first frame constitutes at least a part of the passage.

11. A cartridge comprising:
the toner container according to claim 1; and
a development unit that has a development member that carries toner and a toner chamber that receives the toner discharged from the outlet port of the toner container.

12. An image forming apparatus comprising:
the toner container according to claim 1; and
an image forming unit configured to form an image on a recording material using the toner discharged from the outlet port of the toner container.

13. The image forming apparatus according to claim 12, further comprising a pump configured to eject air toward the inlet port of the toner container.

14. The toner container according to claim 1, further comprising
a first frame and a second frame constituting a frame of the toner container,
wherein the filter is arranged between the first frame and the second frame, the first frame and the filter form a space of the container chamber, and the filter and the second frame form a space of the air chamber,
wherein the outlet port is provided in the first frame, and the inlet port is provided in the second frame.

15. The toner container according to claim 1, further comprising
a first frame and a second frame constituting a frame of the toner container,
wherein the filter is arranged between the first frame and the second frame, the first frame and the filter form a space of the container chamber, and the filter and the second frame form a space of the air chamber,
wherein the ventilation port is provided in the first frame.
